(19) United States
(12) Patent Application Publication
(10) Pub. No.: US 2011/0023732 A1
(43) Pub. Date: Feb. 3, 2011

(54) Round Baler With Variable Speed Baling Mechanism

(75) Inventor: Maynard M. Herron, Hesston, KS (US)

Correspondence Address: AGCO Corporation, Legal Department, 4205 River Green Parkway, Duluth, GA, 30096, US

(73) Assignee: AGCO CORPORATION, Duluth, GA (US)

(21) Appl. No.: 12/645,595

(22) Filed: Dec. 23, 2009

Related U.S. Application Data
(60) Provisional application No. 61/230,381, filed on Jul. 31, 2009.

(51) Int. Cl. A01F 15/07; A01F 15/08

(52) U.S. Cl. 100/40; 100/78

(57) ABSTRACT

In an example embodiment, a baler includes a variable speed baling chamber. The variable speed baling chamber may include a baling chamber and a variable speed drive. A method of baling crop material includes running a baling chamber at a first speed during a bale-forming cycle and running the baling chamber at a second speed during a non-bale-forming cycle, such as a bale wrapping cycle.

### CROSS REFERENCE TO RELATED APPLICATIONS

This application claims priority to co-pending U.S. Provisional Application No. 61/230,381, entitled “Combine Harvester and Baler For Biomass Collection,” filed Jul. 31, 2009, which is incorporated herein by reference. This non-provisional application is related to U.S. non-provisional patent application entitled “Continuous Round Baler” (attorney docket no.: A1009H) and U.S. non-provisional application entitled “Continuous Round Baler With Pickup” (attorney docket no.: A1047H) both of which are entirely incorporated by reference herein.

### TECHNICAL FIELD

The present invention relates generally to round balers, and more specifically, to round balers with rotational baling chambers.

### BACKGROUND

Conventional round balers receive crop material and form the crop material into compacted bales in a baling chamber. There are generally three major cycles in the operation of a round baler: a bale-forming cycle, a bale-wrapping cycle, and a bale-ejecting cycle. The baling chamber is typically run at a constant rotational speed throughout its bale-forming and bale-wrapping cycles. In a typical round baler in which the baling chamber turns at a rotational speed of about 500 feet per minute, it takes about 20-25 seconds to perform the bale-wrapping and bale-ejecting during which time the tractor is stopped.

### BRIEF DESCRIPTION OF THE DRAWINGS

FIG. 1 shows a schematic of an example embodiment of a variable speed round baler.

FIG. 2 shows a drawing of an example embodiment of a variable speed round baler of FIG. 1.

FIG. 3 shows a schematic view of an example embodiment of a control console at a vehicle that is accessible by an operator when towing the round baler of FIG. 2.

FIG. 4 shows a schematic view of an example control console at a vehicle that is accessible by an operator when towing a variable speed baler.

FIG. 5 shows a flow diagram of an example method of operating a baling chamber of a round baler.

FIG. 6 shows a flow diagram of the operation of a variable speed baling chamber.

FIG. 7 shows a flow diagram of the operation of a baler having a variable speed baling chamber.

### DESCRIPTION OF EXAMPLE EMBODIMENTS

### Overview

In an example embodiment, a variable speed baler is configured to vary the speed of a baling mechanism in accordance with a predetermined scheme. In one example embodiment, the baler varies the rotational speed of a baling chamber in accordance with the operational cycles of the baler. For example, the baling chamber may be run at a first speed during a bale-forming operation and at a second speed during non-bale-forming operations, such as a bale-wrapping operation. The term “crop material” is intended to include grain and/or material other than grain (MOG), such as crop residue from a combine. For example, the baler may be used for baling hay or biomass material such as corn cobs or the like or a mixture of the two. This arrangement provides several advantages over prior art systems, including the ability to decrease the operational time required for making and wrapping a bale and decreasing stop times of the baler.

In one example embodiment, a variable speed baler comprises a baling chamber adapted to form crop material into a bale and wrap the bale; and a variable speed drive configured to manipulate the speed of the baling chamber in accordance with a predetermined scheme. For example, the speed of the baling chamber may be manipulated in accordance with the operational cycles of the baler, such as whether the baler is in a bale-forming cycle or a non-bale-forming cycle, such as a bale-wrapping cycle. The variable speed baler may further comprise a sensor for determining the various cycles of operation of the baling mechanism.

An example method comprises receiving crop material at a baling chamber of a round baler; and varying the speed of the baling chamber in accordance with a predetermined scheme. In one example embodiment, the predetermined scheme includes varying the speed of the baling chamber in accordance with an operational cycle of a baler. The method may further comprise determining an operational cycle of the baler.

### DETAILED DESCRIPTION

As required, example embodiments of the present invention are disclosed herein. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which example embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention.

It should be noted that whereas the example embodiments are discussed in the context of a tractor-towed baler having a conveyor for feeding crop material to a baling chamber, the invention is not so limited and alternate arrangements could be used, such as an arrangement whereby a pickup is provided adjacent the baling chamber as known in the prior art. For example, an alternate arrangement could be used in conjunction with a round baler such as that disclosed in related patent application A1047H.

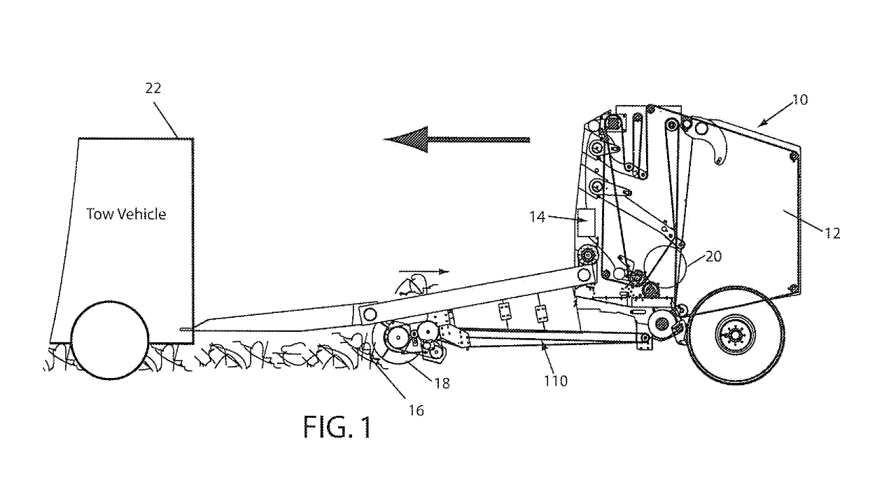

Turning to the figures, FIG. 1 shows a schematic of a variable speed baler 10 that includes a baling chamber 12 configured for forming a bale 20 and a variable speed drive 14 for varying the speed of the baling chamber 12. A vehicle, such as a tractor 22 may be used to power the baler 10 and pull it through the field as indicated by the large arrow in FIG. 1.

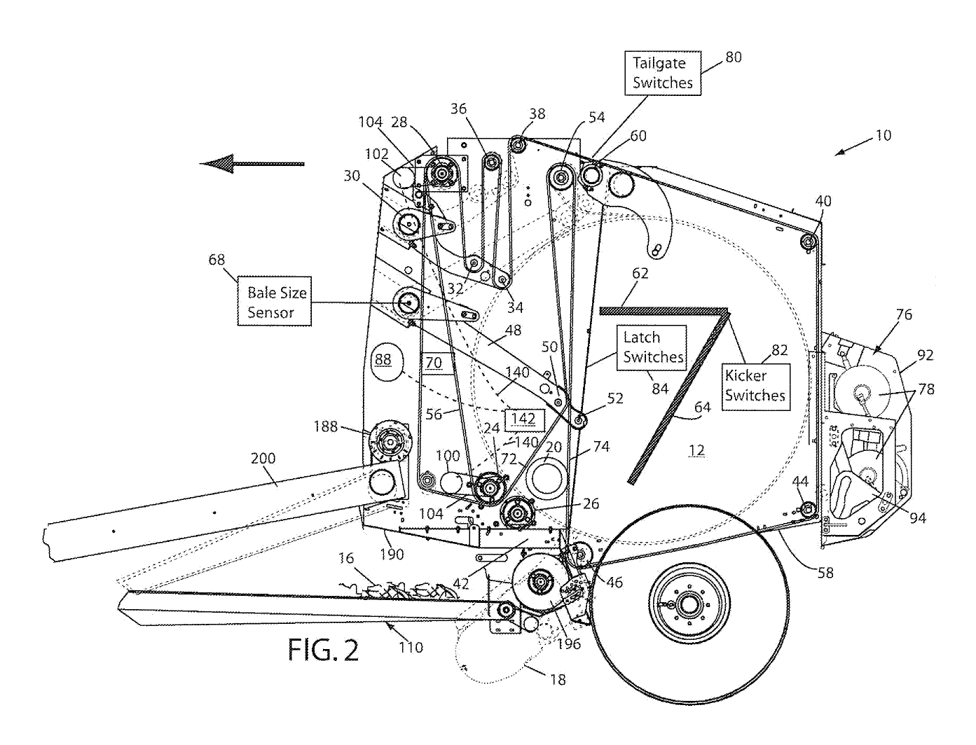

As shown in FIG. 2, the baler 10 may be generally similar to the balers produced by AGCO Corp. and disclosed in U.S. Pat. Nos. 7,3376,713; 6,477,824; 6,675,561; 4,850,271; and 4,524,867 all incorporated in their entirety into the present application by reference. The baling chamber 12 of the baler 10 may comprise a number of rolls and belts that cooperate to assume different shapes and sizes throughout a bale-forming cycle. In this respect, the example round baler 10 may be referred to as a “variable chamber” belt type machine, wherein the baling chamber 12 is initially small, and then grows progressively larger as the bale 20 increases in diameter within the baler 10. It will be appreciated, however, that the principles of the present invention are also applicable to a “fixed chamber” machine (not shown) in which the dimensions of a baling chamber are at least substantially constant throughout the baling cycle.

With the foregoing general explanation in mind, in the example embodiment shown in FIG. 2, a bale forming chamber 12 includes a lower drive roll 24 and a starter roll 26. Above the lower drive roll is an upper drive roll 28. Pivotally mounted within the baler is a belt tension arm 30 to which are pivotally mounted the front belt tension roll 32 and a rear belt tension roll 34. At the top of the front portion of the baling chamber are a front upper idler roll 36 and a rear upper idler roll 38. Following the interior of the baler wall around clockwise, there is a tailgate belt roll 40, a lower rear tailgate roll 44, and front lower idler roll 46. A bale density arm 48 is pivotally mounted within the baler and has a front bale density roll 50 and a rear bale density roll 52, both pivotally mounted on the distal end from the pivotal mounting of the bale density arm 48. Near the top of the baling chamber above the bale density rolls is depicted an upper baling chamber roll 54. A plurality of bale forming belts 56 (one shown in profile) are threaded around each of the above identified rolls as depicted in FIG. 2. The bale forming belts are tensioned by the front and rear belt tension rolls 32, 34, mounted on the belt tension arm 30 and the rolls 50, 52 mounted on the bale density arm 48.

The baling chamber 12 is open at the bottom to provide a chamber inlet 42 defined generally between the starter roll 26 and the idler roll 46. The baling chamber 12 may be located above and off the ground and a means provided for picking up crop material and delivering the picked-up material into the baling chamber 12. In the example embodiment a conveyor 110 is used to provide crop material to the baling chamber. However, as shown in dashed lines in FIG. 2, in lieu of the conveyor, a pickup header 18 could be provided adjacent the baling chamber 12 as known in the art. In the example embodiment, a pickup header 18 having a standard resilient rotary rake tine assembly for picking crop up off the ground may be used. If desired, the rake tine assembly selected for use may be wider than the baling chamber 12 in a direction transverse to the path of travel of the machine, in which case the baler may be provided with center-gathering stub augers.

Windrowed crop material 16 may be fed into the baler 10 by the pickup assembly 18 and moved to the chamber inlet 42 and fed into the bottom of the open throat baling chamber 12 either directly when the pickup is adjacent the baling chamber (shown in dashed lines in FIG. 2) or by the use of conveyor 110 of a pickup conveyor type arrangement (shown in FIGS. 1 and 2 in solid lines) where the pickup 18 is displaced from the baling chamber 12. When in the baling chamber 12, the crop material 16 contacts the surface of a belt stretch 74 which is moving upward. The forming belts 56 may be driven by the upper 28 and lower 24 drive rolls so that the forming belts 56, 74 carry the crop material 16 to the top of the baling chamber 12 and the motion of the forming belts 56, 72 turns the crop material 10 downward against the starter roll 26 so that a core is started and begins to roll. The crop material 16 may be initially formed into a small bale 20 within the baling chamber 12 and the process continued to form an enlarged bale of a desired size. Although not illustrated in detail, it will be appreciated by one of ordinary skill in the art that the baling chamber 12 may initially assume a generally vertical, triangular configuration when the baling chamber 12 is empty and enlarge as the bale 20 grows in size (shown in dashed lines in FIG. 2).

Once a bale 20 of crop material 16 reaches its full size, it may be desirable to wrap the bale 20 before discharging the bale 20 from the baling chamber 12. Thus, the baler 10 may further broadly include a wrapping apparatus 76 for wrapping a formed bale 20 with a wrapping material 78 once the bale-forming cycle has been completed.

The bale wrapping apparatus may be configured to wrap the bale 20 in mesh or twine as known in the art. In the example embodiment shown in FIG. 2, the wrapping apparatus 76 may be a mesh wrap similar to that disclosed in U.S. Pat. No. 6,050,052 and U.S. patent application Ser. No. 12/365,077 entitled “Meshwrap Dispensing Mechanism for Round Balers” filed Feb. 3, 2009, both of which are assigned to the assignee of the present application and both of which are hereby incorporated herein in their entirety and will not be discussed in detail. It should be noted, however, that the bale 20 is rotated by the baling chamber 12 during a bale wrapping cycle and that the variable speed drive 14 may be used to manipulate the speed of the baling chamber 12 and hence the rotation of the bale 20 during the bale wrapping cycle.

In the example embodiment shown in FIG. 2, the wrapping apparatus 76 is disposed at the rear of baler 20 so that a wrapping material 78 dispensed by the wrapping apparatus 76 travels forwardly to a baling chamber access opening (chamber inlet 42 in the illustrated embodiment, although an alternative opening could be used without departing from the teachings of the present invention) to wrap around the formed bale.

The bale wrapping apparatus 76 may generally include a housing 92 that contains wrapping material 78 and a wrapper dispensing mechanism 94 for paying out lengths of wrapping material 78 during the bale wrapping cycle. The wrapping material 78 may be paid out into the baling chamber 12 so that it contacts the bale 20 as the bale 20 is rotated in the baling chamber by the forming belts. A cutting assembly (not shown) may also be provided to sever the wrapping material 78 such that the fully formed and wrapped bale 20 may be ejected from the baler 10 so that formation of a new bale may begin.

The example baler includes a tailgate 58 that opens and closes around pivot point 60. A bale kicker assembly 62 (shown schematically) is associated with the tailgate. The bale kicker assembly includes the bale push bar 64 (depicted in its home position) and two hydraulic cylinders (not shown). The bale kicker is used to prevent contact between the tailgate 58 and the bale when the tailgate is closing. After the tailgate rises, hydraulic pressure is applied to the base end of the kicker hydraulic cylinders. The bale push bar 64 rises upward and rearward pushing the bale away from the tailgate before the tailgate closes. After the tailgate 58 is closed the kicker is returned to its home position.

The various baling operational cycles of the baler mentioned above may be controlled by a controller 70. The controller may be positioned on or near the round baler 10 and an associated user interface 400 (FIG. 4) that may be positioned on the tow vehicle 22 towing the baler 10. The controller 70 may receive data from a variety of different sensors and in response issue commands to effect various operations of the baler 10. Although the controller 70 and the user interface 400 are preferably separate components, their functions could also be combined into a single unit positioned either on the baler 10 or its towing vehicle. The baler controller 70 may be used to control the operation of the baler 10, including its various operational cycles, such as the bale forming, bale wrapping, and bale ejecting cycles and the speed of the baling chamber 12. For example, a bale size sensor 68 (shown schematically) may determine the bale size of the bale 20 in the baling chamber 12 and provide a corresponding signal to the controller 70 and the user interface 400. For example, the bale size sensor 68 may send signals to the electronic control system to indicate the bale size during the bale forming cycle. The controller 70 may then determine the desired operational speed of the baling chamber 12 and issue commands to effectuate the desired operational speed. In addition, the baler can include tailgate switches 80 (shown schematically) that detect the position of the tailgate whether opened or closed, kicker switches 82 (shown schematically) that detect the position of the kicker whether out or home, and latch switches 84 (shown schematically) that detect whether the tailgate is latched. The tailgate and kicker switches cause signals to be sent to the controller 70 indicating the status of the elements to which they are connected. The controller may then use the information to move the baler 10 through the various operational modes and vary the speed of the baling chamber 12 accordingly.

Power for operating the components of the baler 10 can be delivered by a drive line (not shown) associated with a tongue 200. A front end of such a drive line can be adapted for connection to the power take-off shaft (also not shown) of the towing vehicle, while the rear end of the driveline can be coupled with a gearbox 188 or other components mounted to a chassis 190. The gearbox 188 may be coupled with various drives and/or other components for the driving the various baler components. In addition to the elements described above, the baler 10 can include a hydraulic pump 88 that may be used to power various components such as hydraulic motors and cylinders. The baler may also include a clutch assembly and control electronics, neither of which is shown in FIG. 2, but which are necessary for operation of the baler as will be understood by one of ordinary skill in the art. In an alternative embodiment in lieu of the pickup 18 a conveyor 110 may provide crop material to the baler as disclosed in U.S. patent application No. [the continuous baler application].

In the example embodiment shown in FIGS. 1 and 2, the baling chamber may be powered by a variable speed drive 14 in the form of a hydrostatic system. For example, the bale forming belts 56 may be driven by the lower 24 and upper 28 drive rolls whose rotation results in movement of the bale forming belts 56. The drive rolls 24, 28 may in turn be powered by hydraulic motors 100, 102. For example, fluid may be provided to the hydraulic motor 100, 102 from the hydraulic pump 88 and manipulated by solenoids and/or flow control valves to vary the fluid flow to vary the speed of the motors 100, 102. The drive rolls 24, 28 may be coupled to the motors 100, 102 by a chain 104 or other means as known in the art so that varying the speed of the motors 100, 102 varies the speed of rotation of the drive rolls 24, 28 and the bale forming belts 56 powered by the drive rolls 24, 28 and therefore the rotational speed of the bale 20.

This arrangement allows the rotational speed of the bale 20 in the baling chamber to be controlled by the controller 70 by varying the speed of the forming belts 56. This speed may be varied in different operational cycles of the baler 10. For example, the rotational speed may be at a first value during a bale forming operation and at a second value during the bale wrapping operation. In an example embodiment, the hydraulic pump 88 may be mounted in the baler and powered by a power takeoff (PTO) mechanism of the vehicle. Hydraulic lines 140 may extend to a manifold 142 mounted in the baler 10 and be coupled to solenoids and/or flow control valves that respond to command signals sent from a controller 70 to manipulate hydraulic fluid provided to the motors 100, 102. In an example embodiment, a baling chamber on solenoid 334, a baling chamber off solenoid 336, and a baling chamber flow control valve 332 (all shown schematically in FIG. 4) may be communicatively coupled to the controller 70 and used to control the hydraulic motors 100, 102 and thus the movement of the bale forming belts 56. The controller 70 may also manipulate other components of the baler 10 related to the baler's various operating cycles. Although in the example embodiment two hydraulic motors 100, 102 are employed a single hydraulic motor may be used power both the drive rolls 24, 28. For example, a motor could be coupled to the drive rolls by a chain or belt.

The baling chamber 12 may be manipulated by the controller 70 in accordance with a predetermined scheme programmed by an operator. In one example scheme, the baling chamber 12 may be driven at different speeds in conjunction with the different operation cycles of the baler 10. For example, the bale forming belts 56 may be driven at a first speed during a bale forming cycle of the baler 10 and a second faster speed during the bale wrapping cycle. This allows for a decreased wrapping time over conventional balers in which a single speed is used throughout both the bale forming and bale wrapping operations.

Various sensors in the baler 10 can be used by the controller 70 to control the operating cycles of the baler 10 and the movement of the bale forming belts 56. For example, the controller 70 may direct the baler 10 to begin a bale forming cycle and operate the baling chamber 12 at a first speed if the bale size sensor 68 indicates that the bale 20 is less than a predetermined size and to operate the baling chamber 12 at a second speed if the bale size sensor 68 indicates that the bale 20 is equal to or greater than the predetermined size. Likewise, the controller 70 may direct the entry of the bale wrapping cycle when the bale reaches a particular size, direct entry of the bale ejection cycle when the wrapping cycle is complete, and stop the bale forming belts 56 during a bale ejection cycle. Upon completion of the ejection cycle, the controller may restart the forming belts 56 to form a new bale. For example, when sensors, such as the tailgate switch 80, indicate that the bale 20 has been ejected from the baler 10, the controller 70 may begin a new bale forming cycle and restart the baler belts 56.

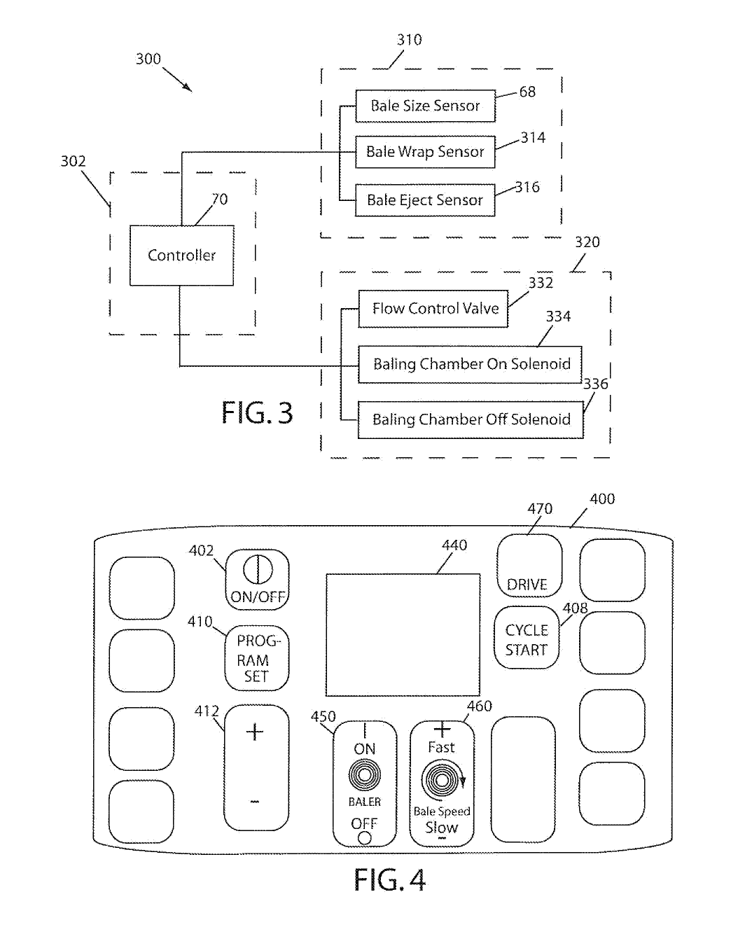

FIG. 3 is a schematic drawing of an embodiment of an electronic control system 300 of the variable speed baler 10 of FIG. 2. The system 300 comprises a system box 302 containing a controller 70 and associated electronic components whose construct will be understood by one of ordinary skill but the details of which are unimportant to the present invention. The arrangement may be comprised of hardware, software, firmware or combination thereof as would be apparent to one of skill in the art. For example, the controller 70 may be a microcontroller capable of receiving data and issue commands for the control of various systems and components in accordance with particular schemes that may be programmed into the microcontroller.

Communicatively coupled to the system box 302 and the controller 70 are a sensor box 310 for providing data to the controller and a control box 320 for receiving commands from the controller 70 controlling the speed of the baling chamber 12 by manipulating various parts of the variable speed drive. The sensor box 310 may comprise one or more sensors for communicating information to the controller for use in generating various command signals. In the example embodiment shown in FIG. 3, the sensor box 310 includes a bale size sensor 68, a bale wrap sensor 314, and a bale eject sensor 316 for providing information to the controller 70 regarding the operation of the baler 10. For example, the bale size sensor 68, may indicate the size of the bale 20 within the baling chamber 12 and indicate when the controller should direct the baling chamber 12 to exit a bale-forming mode enter a bale-wrap mode. The wrap sensor 314 may indicate when a bale wrapping operation is complete and the controller should direct the baling chamber to enter an eject mode. The bale eject sensor 316 may indicate when the bale ejection operation is complete and the controller should direct the baling chamber to enter the bale-forming cycle. For example, the bale eject sensor 314 may be a tailgate latch switch 84 that indicates when the baler tailgate 58 closes after the bale is ejected.

Various elements controlled by the controller 70 may be distributed about the round baler 10 and will not be discussed in detail. For example, the system box 302 and controller 70 may be coupled to solenoids and control valves to operate hydraulic devices control various hydraulic cylinders to open and close the tailgate 58, operate the kicker assembly 62 for ejecting the bale, and operate the wrap assembly 76 for wrapping the bale 20.

As seen in FIG. 3, the controller 70 may also be communicatively coupled to a control box 320. In the example embodiment shown in FIG. 3 the control box 330 comprises a flow control valve 332, a baling chamber on solenoid on 334, and a baling chamber off solenoid off 336 that are controlled by the controller 70 and used to manipulate the operation of the forming belts 56 in response to commands from the controller. For example, the controller 70 may issue commands to change the flow of fluid to the hydraulic motors 100, 102 to change the speed of the motors and the forming belts 56. While not discussed in detail, one of skill in the art will recognize that the controller and pump 88 could be used for manipulating other components of the baler 10, such as the starter roll 26.

FIG. 4 is a plan view of a user interface in the form of a control console 400 provided at an operator's station, such as in the cab of the towing tractor that pulls the baler 10 through the field. The control console 400 may be configured with controls to provide the operator with different levels of control over the baler 10. The control console 400 may include a variety of other controls for controlling various other parts of the baler 10 such as the pickup 18, clutch (not shown), tailgate 58, kicker 62, wrapper assembly 76, etc. which are omitted for purposes of clarity. The control console 400 could also be configured to operate in different modes of operation such as a manual mode or an automatic mode. For example, the operator may be provided with manual control mode of the round baler or automatic control mode. In full manual control mode the operator may initiate various operational cycles of the baler 10, whereas in the automatic mode the various cycles may be initiated automatically with little or no operator assistance.

In the example embodiment 400 shown in FIG. 4, the control console 400 includes a power on/off button 402, a cycle start button 408, a program set button 410, a value control button 412. In addition, there may be a variety of other control buttons for operating other features of the baler that will not be described in detail. There is also a central display 440 that indicates baler status to the operator during the various baler operational cycles. In addition to the control console 400, a remote control (not shown) may also be used to handle some control functions including the cycle start function described below.

The controller 70 can have a variety of modes of operation including a manual and an automatic mode. The system starts in the neutral mode. At system start up certain checks may be performed by the system and the baler and status displayed to the operator. From the neutral mode the operator can enter the program mode by pressing the program set key 410.

The operator may then set the various settings for controlling the baler. For example, when the program set key 410 is pressed a program mode symbol may illuminate and a setting name and value will appear on the display screen 440. To change a value or setting option, the operator can press the appropriate side of value key 412. The program set button 410 can be pressed again to advance to the next setting name. Among other values and settings, the baler can be set in automatic mode during the program mode and a baling chamber scheme selected.

In a manual mode, the operator can use a baling chamber On/Off key 450 to turn the baling chamber 12 on/off and use a baling chamber speed key 460 to vary the speed of the baler by pressing the + or − portion of the key 460. For example, an operator can use the Baler On/Off key to actuate the baling chamber on solenoid 334 and baling chamber off solenoid 336 to start and stop the rotation of the baler forming belts 56 and the baling chamber speed key 460 to manipulate the speed of the baler forming belts 56. For example, when the baler 10 is first started, a user in manual mode may select the baler on key to activate the baler and the baling chamber speed key 460 to set a speed of the baling chamber 12 during a bale forming operation of the baling chamber 12. When the baling chamber 12 has completed the bale, the operator may use the baling chamber speed key 460 to increase the speed of the baling chamber 12 by increasing the speed of the forming belts 56. When the wrapping operation is complete, the user could use the baling chamber On/Off key 450 to stop the bale forming belts during an ejection cycle and, once the bale is ejected, use the Baler On/Off key to restart the bale forming belts 56 to initiate the bale forming operation of a new bale.

If an operator chooses an automatic mode then the baler 12 may advance through the various operational cycles without operator intervention under the control of the controller 70. The operator may select a particular scheme under which the baling chamber 12 will operate. For example, the operator could be provided with a choice of various operational schemes from which to choose. For example, one predetermined scheme may operate the baling chamber 12 in accordance with the operational cycles of the baler, such as operating the baling chamber 12 at a first speed during bale-forming cycles and at a second speed during bale-wrapping cycles. In one particular scheme the rotational rpm of the bale may be twice that of the final bale forming speed to significantly decrease the wrap time.

A bale forming operation may be initiated by depressing drive key 470. When the drive mode is entered the clutch is engaged and the hydraulic motor(s) 100, 102 are powered to begin turning the forming belt 56. The operator may drive the tractor pulling the baler 10 behind it as the baling chamber 12 forms the bale 20. The operation of the various modes of the baler 10 may be similar to the disclosed in U.S. Pat. No. 6,675,561 entitled “Round Baler Semi-Automatically Sequenced Operating Cycles and Selectively Variable Point of Operator Intervention”, which is incorporated by reference herein, and include the bale forming, bale wrapping, and bale ejection modes which may operated manually with operator intervention or automatically with little or no operator intervention. Once in manual mode, the operator may control various aspects of the baler using various buttons on the controller such as the clutch, the wrapper assembly, the tailgate, and the ejection. The baling chamber on/off button 450 and the baling chamber speed button 460 may be used to manually control the speed of the bale forming belts 56 and hence the speed of the baling chamber 12 and the rotation of the bale 20 when the system is operating in the manual mode. For example the buttons 450, 460 may send signals to the controller 70 for manipulating the baling chamber on solenoid 334 and the baling chamber off solenoid 336 and the flow control valve 332, respectively.

The baling chamber 12 may operate as follows. The variable displacement pump 88 within the baler 10 receives energy from the power take-off of the towing vehicle and pressurizes the system. When the operator signals the beginning of the bale formation cycle by depressing drive key 470, the electronic controller 70 sends a signal to the baling chamber on solenoid 334 and baler flow control valve 332 which causes the hydraulic motor(s) 100, 102 to operate and the starter roll 26 to turn, and upper and lower drive rolls 24, 28 to turn the forming belts 56.

Crop material 16 is picked up by the pickup header 18 and fed into the bottom of the open throat baling chamber 12 by a feeder 196. Once in baling chamber 12, the crop material 16 contacts the rough top surface of forming belts 56-74 which are moving upward. The forming belts 56 carry the crop material 16 to the top of the starting chamber which is formed by the front and rear bale density rolls 50, 52. The motion of the forming belts 56-72 turns the crop material downward against starter roll 26. The core is started and begins to roll. Hydraulic cylinders pull down on the bale density arm 48 and belt tension 30 arms. The bale density rolls 50, 52 are held down to reduce the size of the baling chamber to a starting size. The belt tension rolls 32, 34 are held down to supply tension to the forming belts. As the bale increases in size, the bale density rolls 50, 52 and the belt tension rolls 32, 34 are forced up. The bale density rolls 50, 52 put an increasing amount of downward force against the bale. This force keeps tension on the bale and compresses the crop material coming into the baling chamber. The belt tension rolls move upward to provide more forming belt for the increased size of the bale within the chamber.

As the bale size increases and bale density arm 48 moves upward, the bale size sensor 68 continually sends signals to controller 70 indicating bale size. The controller 70 will detect when the bale has reached or exceeded a desired bale size, which may have been originally programmed during the program mode by the operator. The bale size may also be indicated on the console screen 440. If the baler 10 is operating in automatic mode, then when the bale size has reached or exceeded the predetermined bale size, the baler 10 enters the wrapping cycle and the baling chamber rotational speed changes in response to the new baler mode. For example, the controller 70 may send a signal to the baler flow control 332 to speed up the forming belts 56 during the wrapping cycle to increase the rotational speed of the bale 20. The controller may also send a signal to the wrapping mechanism 76 to start the bale wrapping cycle.

For example, the controller 70 may activate the wrapping mechanism 76 to feed the wrapping material 78 into the baling chamber 12 to wrap the bale 20 as the bale 20 is turned by the forming belts 56. The wrap mechanism 76 performs its function as will be readily understood by one of ordinary skill in the art, such as by the method disclosed in [CITE WRAP APPLICATION]. However, unlike traditional balers, the speed of the baling chamber 12 is changed from the speed used during the bale forming cycle. For example, the rotational speed of the baling chamber 12 may be sped up to decrease the wrap time. The bale wrap sensor 314 may indicate to the controller 70 when the bale wrapping cycle is complete. For example, the bale wrap sensor 314 may indicate when a predetermined length of wrap has been provided to the bale 20 that is sufficient for wrapping.

The controller 70 may then proceed to a bale ejection cycle in which the controller 70 causes the tailgate 58 to lift, such as by actuating a tailgate up solenoid (not shown) and activating a kicker assembly 62 to push the bale 20 away from the baler 10. The controller 70 may then activate the baling chamber off solenoid 336 to stop the forming belts 56 during the ejection cycle.

Once the bale 20 is ejected from the baler 12 the controller 70 may close the tailgate 58, such as by actuating a tailgate down solenoid (not shown). The bale eject sensor 316 may signal to the controller 70 when the ejection cycle is complete. For example, the bale eject sensor 316 may comprise a tailgate latch switch 84 which indicates when the tailgate is closed after the bale 20 is ejected. The baler 10 then immediately begins a new forming cycle. For example, the controller 70 may activate the baling chamber on solenoid 334 and the flow control valve 332 to operate the bale forming belts 56 at a desired bale forming speed.

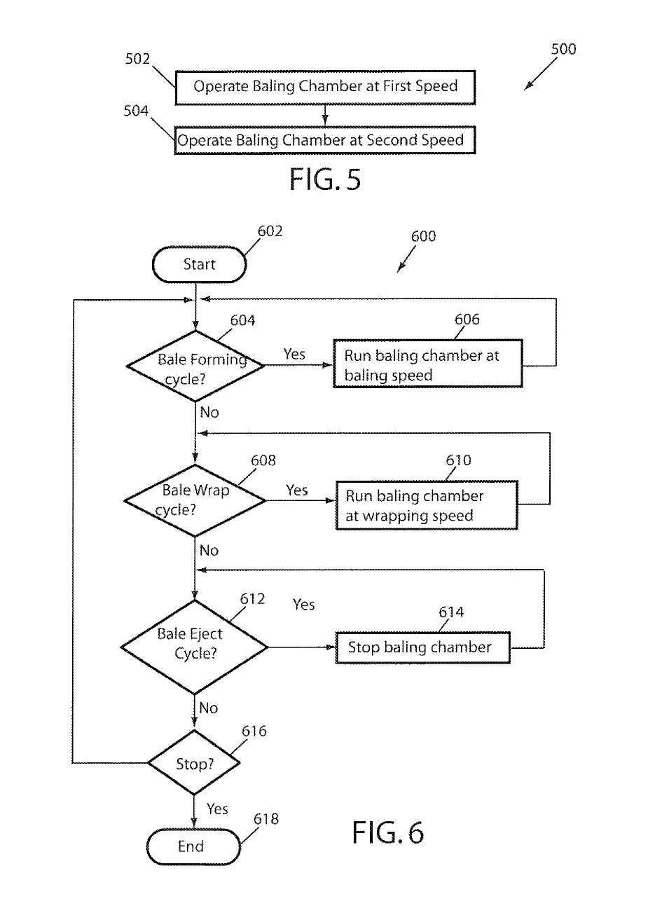

FIG. 5 shows an example flow diagram of a baling chamber operation 500 in which the baler 10 has a variable speed baling chamber 12. At block 502 the baling chamber is operated at a first speed during a bale forming cycle. For example, the baling forming chamber may be operated at a rotational rpm that is twice the final bale forming speed.

FIG. 6 shows an example flow diagram 600 of the operation of a variable speed baler 10. At block 602 the baler is started. For example, as discussed above, an operator may start the baler 10. At block 604 a determination is made whether the baler 10 is in a bale forming operational cycle. For example, the controller 70 may initiate a bale forming cycle upon start up of the baler 10 or upon the ejection of a previous bale. If the baler 10 is in a bale forming cycle, then at block 606 the baling chamber 12 is run at a first speed suitable for baling. A determination may be continually made such that when the baler is in a bale-forming operational cycle the baling chamber 12 is run at the first speed.

If a determination is made at block 604 that the baler 10 is not in a bale forming cycle then at block 608 a determination is made as to whether the baler 10 is in a bale wrap operational cycle. For example, the controller 70 may receive information from a sensor, such as a bale size sensor 68 that the bale 20 is of sufficient size for wrapping and the controller 70 may then issue commands to initiate the bale wrapping cycle. If the baler is in the bale wrapping cycle, then at block 610 the baling chamber 12 is run at a high speed. For example, as discussed above, the controller 70 may issue commands to a flow control valve 320 to increase the speed of an associated hydraulic motor 100. If the baler is not in the bale wrap cycle, then at block 612 a determination is made as to whether the baler 10 is in a bale ejection cycle. For example, a sensor 314 may indicate that the bale wrapping is complete and that the baler 10 should enter a bale ejection cycle at which point the controller 70 may issue the necessary commands at block 614 to stop the baling chamber. For example, the controller 70 may activate the baling chamber off solenoid 336 to stop rotation of the baling chamber 12.

At block 616 a determination may be made as to whether a stop command has been issued, such as whether an operator has used the baling chamber on/off switch 450. If the stop command is issued then the baling chamber may remain stopped at block 618. If a stop command is not received, then a new determination may be made at block 604. It should be noted that whereas in the example flow 600 in FIG. 6 the speed of the baling chamber is changed automatically by the controller 70, the operator could operate in a manual mode and use the baling chamber control button 460 to change the speed of the baling chamber 12. For example, input from the operator using the fast/slow control button 460 could be used to manipulate the flow control valve 332 in accordance with the operator's preferences.

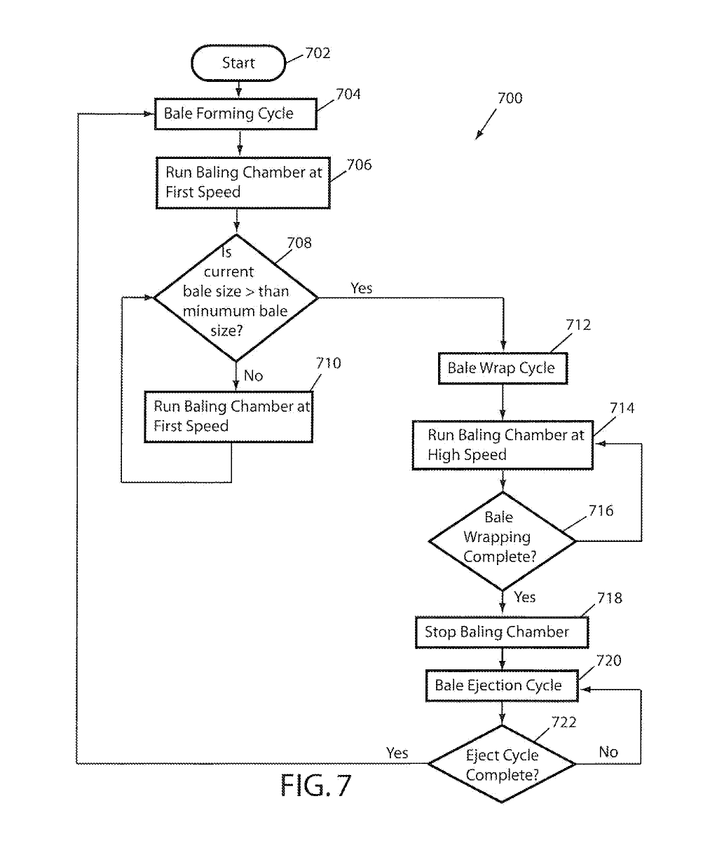

FIG. 7 shows an example flow diagram 700 of an operation of a variable speed baler 10. At block 702 the operation may be started and at block 704 the baler enters a bale forming cycle and at block 706 the baling chamber is operated at a first speed. As discussed above, during a bale forming process a core is formed into a small bale 20 which grows progressively larger. At block 708 a determination is made as to whether the size of the bale is of a desired size, such as the size of a standard bale. For example, a bale size sensor 68 may be used to determine the bale size. If the bale is not of desired size at block 710 then the baling chamber continues to run at the first speed in block 710. If the bale is of a desired size at block 708 then the baler 10 enters a bale wrap cycle at block 712.

In order to quickly wrap the bale 20, the baling chamber is run at a second speed, such as a high speed, at block 714 during the bale wrapping cycle. At block 716 a determination is made as to whether the bale wrapping is complete. For example, a bale wrap sensor 314 may be used to indicate when the bale wrapping is complete. If bale wrapping is not complete, then the baler wrapping cycle continues and the baling chamber 12 continues to be run at high speed. If the bale wrapping is complete then at block 718 the speed of the baling chamber is stopped and a bale ejection cycle begins at block 720. A determination is made as to whether the bale ejection cycle is complete at block 722 and if so, a new bale forming cycle is begun at block 704 and the baling chamber is run at the first speed in block 706.

It should be noted that, whereas three particular operation cycles, bale-forming, bale-wrapping, and bale ejection, have been discussed, the term “cycle” is meant to incorporate other existing or future operations that could be performed by a baler and is not limited to the specific afore-mentioned cycles. Thus, many other cycles could be performed by the baler 10, and the speed of the baling chamber 12 adjusted accordingly.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings, in addition to the scope of the invention defined by the claims.

What is claimed is:

1. A variable speed baler, comprising:
a baling mechanism; and
a variable speed mechanism for manipulating the speed of the baling mechanism.

2. The variable speed baler of claim 1, further comprising:
a controller configured to control the variable speed mechanism to operate the baling mechanism in accordance with a predetermined scheme.

3. The variable speed baler of claim 1, wherein the predetermined scheme comprises:
manipulating the speed of the baling mechanism in accordance with an operational cycle of the variable speed baler.

4. The variable speed baler of claim 1, wherein the predetermined scheme comprises:
operating the baling mechanism at a first speed during a bale-forming operational cycle of the baler; and
operating the baling mechanism at a second speed during a non-bale-forming operational cycle of the baler.

5. The variable speed baler of claim 1, wherein the predetermined scheme comprises:
operating the baling mechanism at a first speed during a bale-forming operational cycle of the baler; and
operating the baling mechanism at a second speed during a bale-wrapping operational cycle of the baler.

6. The variable speed baler of claim 5, wherein the second speed is faster than the first speed.

7. The variable speed baler of claim 1, wherein the variable speed drive comprises a hydraulic drive.

8. The variable speed baler of claim 7, wherein the hydraulic drive comprises:
a variable speed pump; and
a hydraulic motor in fluid communication with the variable speed pump and rotatably coupled to a forming belt of the baling mechanism.

9. The variable speed baler of claim 1, wherein the baling mechanism comprises a baling chamber.

10. The variable speed baler of claim 1, wherein the baling chamber comprises at least one forming belt.

11. The variable speed baler of claim 1, further comprising:
a user interface configured to receive input from a user to control a speed of the baling mechanism.

12. A method, comprising:
varying the speed of a baling mechanism of a round baler in accordance with a predetermined scheme.

13. The method of claim 12, wherein said varying the speed of a baling mechanism in accordance with a predetermined scheme, comprises:
varying the speed of the baling mechanism in accordance with an operational cycle of the round baler.

14. The method of claim 12, wherein varying the speed of a baling mechanism in accordance with a predetermined scheme, comprises:
varying the rotational speed of a baling chamber of the round baler in accordance with a predetermined scheme.

15. The method of claim 12, further comprising determining an operational cycle of the baler.

16. The method of claim 12 wherein said varying the speed of a baling mechanism in accordance with a predetermined scheme, comprises:
running the baling mechanism at a first speed during a bale-forming cycle; and
running the baling mechanism at a second speed during a non-bale-forming cycle.

17. The method of claim 16, wherein said varying the speed of a baling mechanism in accordance with a predetermined scheme, comprises:
running the baling mechanism at a first speed during a bale-forming cycle; and
running the baling mechanism at a second speed during a bale-wrapping cycle.

18. The method of claim 16, wherein the second speed is faster than the first speed.

19. The method of claim 16, wherein the second speed is at least twice as fast as the first speed.

20. The method of claim 16, further comprising:
running the baling mechanism a third speed during the non-bale-forming cycle.

21. The method of claim 13, further comprising:
determining an operational cycle of the baler.
